(19) United States
(12) Patent Application Publication
(10) Pub. No.: US 2025/0227195 A1
(43) Pub. Date: Jul. 10, 2025

(54) SECURE IMAGE CAPTURE AND ACCESS

(71) Applicant: Safe-Me, LLC, Winnsboro, TX (US)

(72) Inventor: Joe David Gillean, Winnsboro, TX (US)

(21) Appl. No.: 19/073,947

(22) Filed: Mar. 7, 2025

Related U.S. Application Data
(60) Provisional application No. 63/619,642, filed on Jan. 10, 2024.

(51) Int. Cl. H04N 5/77; H04M 1/72412; H04N 5/913; H04N 7/18; H04N 23/51; H04N 23/56

(52) U.S. Cl. CPC H04N 5/772; H04M 1/72412; H04N 5/913; H04N 7/183; H04N 23/51; H04N 23/56

(57) ABSTRACT

A wearable lit camera linked to a mobile device app that automatically loads images to cloud storage to deter criminal activity is disclosed. In one embodiment, A camera device comprises a digital camera, an outwardly facing light source that is communicatively coupled to a control unit, a short-range transceiver communicatively coupled to the control unit, a volatile memory coupled to the control unit, and a non-volatile memory coupled to the control unit and storing a control program which, when executed using the control unit, causes the control unit to execute illuminating the light source, capturing a digital image via the digital camera and storing the digital image in the volatile memory, transmitting the digital image via the short-range transceiver to a mobile computing device, deleting the digital image from the volatile memory, and after a time delay, repeating the capturing, storing, transmitting, and deleting. Use of the short-range transceiver is optional, and other embodiments can use cellular transceivers to upload images directly to the cloud.

### CROSS-REFERENCE TO RELATED APPLICATIONS

This application claims the benefit under 35 U.S.C. 119 (e) of provisional application 63/619,642, filed 10 Jan. 2024, via the restoration of priority, the entire contents of which are hereby incorporated by reference for all purposes as if fully set forth herein.

### TECHNICAL FIELD

One technical field of the present disclosure is digital cameras for use in personal security applications. Another technical field is computer-implemented techniques for the secure capture, uploading, and access to digital images.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

Personal security is a significant concern for individuals in a variety of environments, including but not limited to cities, college campuses, and entertainment venues. Real-time video evidence showing what occurred at a crime scene or during the commission of a crime is commonly dispositive or convincing in many criminal prosecutions. While body-worn cameras are available to law enforcement officers and certain other professionals, consumers do not typically wear cameras.

Consumers sometimes use smartphones to capture video during an incident, but handholding the typical smartphone is inconvenient. In a stressful or dynamic situation, phones can be dropped or lost. Or, if a perpetrator steals or takes a phone with which a consumer had recorded video, the consumer usually loses access to the video, which is locally stored on the phone. Using smartphones for video recording also complicates or renders impossible the consumer's use of the phone for other functions, such as phone calls, which could be urgently needed at the same time as a video recording.

Based on the foregoing, the referenced technical fields have developed an acute need for better ways to enhance personal security via convenient video recording.

### SUMMARY

The appended claims may serve as a summary of the invention.

### BRIEF DESCRIPTION OF THE DRAWINGS

In the drawings:

FIG. 1 illustrates a distributed computer system showing the context of use and principal functional elements with which one embodiment could be implemented.

FIG. 2A is a front elevation view of one embodiment of a camera device.

FIG. 2B is a front elevation view of a second embodiment of the camera device.

FIG. 2C is a side elevation view of the first embodiment of FIG. 2A.

FIG. 2D is an exploded view of another embodiment of the camera device.

FIG. 2E is a perspective view of the camera device of FIG. 2D.

FIG. 2F is a front elevation view, and FIG. 2G is a rear elevation view of the camera device of FIG. 2D.

FIG. 2H is a left side elevation view, and FIG. 2J is a right side elevation view of the camera device of FIG. 2D.

FIG. 2K is a top plan view and FIG. 2L is a bottom plan view of the camera device of FIG. 2D.

FIG. 3 illustrates an example process of operating a camera device and applications in one embodiment.

FIG. 4 illustrates an example program flow associated with law enforcement access to stored digital images.

FIG. 5 illustrates a computer system with which one embodiment could be implemented.

### DETAILED DESCRIPTION

### 1. General Overview

### 1.1 General Principles of Description

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that particular embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 1.2 Subject Matter Clauses

In various embodiments, the disclosure encompasses the subject matter of the following clauses:

Clause 1: A camera device comprising a digital camera; an outwardly facing light source that is communicatively coupled to a control unit; a transceiver communicatively coupled to the control unit; a volatile memory coupled to the control unit; and a non-volatile memory coupled to the control unit and storing a control program which, when executed using the control unit, causes the control unit to execute: illuminating the light source; capturing a digital image via the digital camera and storing the digital image in the volatile memory; transmitting the digital image via the transceiver to a networked storage device; automatically deleting the digital image from the volatile memory; and after a time delay, repeating the capturing, storing, transmitting, and deleting.

Clause 2: The camera device of clause 1 further comprising a wearable enclosure that contains the digital camera, the control unit, the transceiver, the volatile memory, and the non-volatile memory.

Clause 3: The camera device of clause 2, further comprising, attached to the wearable enclosure, means for attaching the wearable enclosure to apparel or to a human body part.

Clause 4: The camera device of clause 3, wherein the means for attaching comprises a spring clip.

Clause 5: The camera device of clause 1, wherein the transceiver comprises a short-range wireless transceiver, wherein the control program when executed using the control unit causes the control unit to execute transmitting the digital image via the short-range transceiver to a mobile computing device.

Clause 6: The camera device of clause 5, wherein the short-range transceiver is a Bluetooth transceiver.

Clause 7: The camera device of clause 1, wherein the light source comprises one or more visible light light-emitting diodes (LEDs).

Clause 8: The camera device of clause 1, wherein the light source comprises one or more static visible light LEDs, one or more colored LEDs, and one or more infrared (IR) spectrum LEDs.

Clause 9: A distributed computing system comprising a camera device comprising a digital camera, an outwardly facing light source that is communicatively coupled to a control unit, a short-range transceiver communicatively coupled to the control unit, a first volatile memory coupled to the control unit, a non-volatile memory coupled to the control unit and storing a control program which, when executed using the control unit, causes the control unit to execute: illuminating the light source; capturing a digital image via the digital camera and storing the digital image in the first volatile memory; transmitting the digital image via the short-range transceiver to a mobile computing device; deleting the digital image from the first volatile memory; and after a time delay, repeating the capturing, storing, transmitting, and deleting; and a mobile app comprising one more first sequences of instructions configured to store in a first non-transitory computer-readable storage media of the mobile computing device and which instructions, when executed using the mobile computing device, cause the mobile computing device to execute: receiving the digital image in a second volatile memory of the mobile computing device; transmitting the digital image via a cellular radiotelephone data transceiver of the mobile computing device and over a data communication network to a server computer; and deleting the digital image from the second volatile memory.

Clause 10: The distributed computing system of clause 9, further comprising a second non-transitory computer-readable storage medium communicatively coupled to the server computer and storing one or more second sequences of instructions which, when executed using the server computer, cause the server computer to execute receiving the digital image from the mobile computing device, encrypting the digital image, and storing the digital image in a storage device after the encrypting.

Clause 11: The distributed computing system of clause 9, wherein the camera device further comprises a wearable enclosure that contains the digital camera, the control unit, the short-range transceiver, the first volatile memory, and the non-volatile memory.

Clause 12: The distributed computing system of clause 11, wherein the camera device further comprises, attached to the wearable enclosure, means for attaching the wearable enclosure to apparel or to a human body part.

Clause 13: The distributed computing system of clause 9, wherein the short-range transceiver is a Bluetooth transceiver.

Clause 14: The distributed computing system of clause 9, wherein the light source comprises one or more visible light LEDs.

Clause 15: The distributed computing system of clause 9, wherein the light source comprises one or more static visible light LEDs, one or more colored LEDs, and one or more infrared (IR) spectrum LEDs.

### 2. Structural & Functional Overview

### 2.1 Distributed Computer System and Device Examples

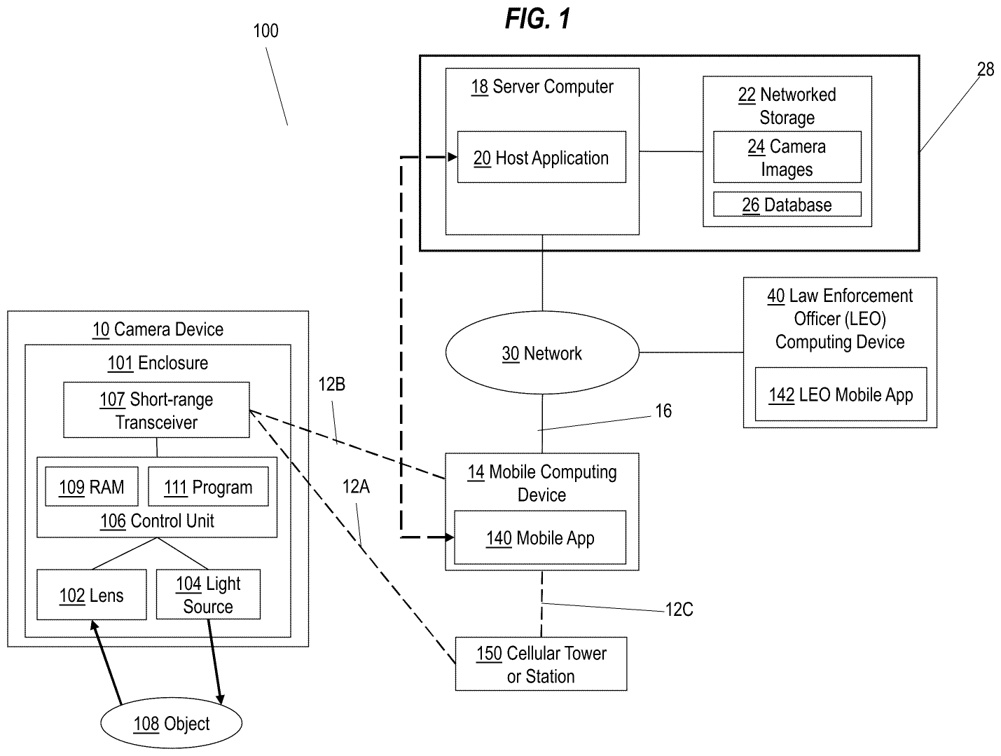

FIG. 1 illustrates a distributed computer system showing the context of use and principal functional elements with which one embodiment could be implemented. In an embodiment, a computer system 100 comprises components implemented partially by hardware at one or more computing devices, such as one or more hardware processors executing stored program instructions stored in one or more memories for performing the functions described herein. In other words, all functions described herein are intended to indicate operations performed using programming in a special or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of secure, continuous digital image capture and storage to enhance personal security. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In an embodiment, a camera device 10 is communicatively coupled via one or more first wireless networking links 12A, 12B to a mobile computing device 14, which is communicatively coupled via one or more second wireless networking links 16 via network 30 to a networked server computer 18 executing a host application 20 and coupled to networked storage 22 storing camera images 24 and hosting a database 26. As further described,

A law enforcement officer (LEO) computing device 40 may also be communicatively coupled via network 30 to the host application 20 and server computer 18. Typically, the server computer 18, host application 20, and networked storage 22 are within a control domain 28 that is owned, controlled, operated, or managed by a service provider that is different than a consumer or end user of the camera device 10 and mobile computing device 14, and independent of any law enforcement officer or entity associated with the LEO computing device 40. In some embodiments, the service provider of the control domain 28 operates or offers a fee- or subscription-based service and establishes unique user accounts for each consumer or other end user of a camera device 10 and mobile computing device 14. The control domain 28 may be subject to physical security controls and security protocols that limit the number and qualifications of persons entitled to access the networked storage 22, camera images 24, and database 26.

Each of the mobile computing device 14 and LEO computing device 40 may comprise a smartphone, tablet computer, laptop computer, desktop computer, workstation, or other computing device and hosts or executes a mobile app 140 or LEO mobile app 142 that executes the functions described more fully in other sections herein. The LEO mobile app 142 may be a copy of an instance of the mobile app 140 with additional security and validation functions as further described. In one embodiment, the mobile computing device 14 comprises a smartphone or other computing device having an integrated cellular radiotelephone transceiver, and the second wireless networking link 16 represents a cellular radiotelephone data connection between the mobile computing device and the network 30. The second wireless networking link 16 can include a cellular link 12C to a cellular tower or base station that connects to the network 30.

Network 30 broadly represents any one or more wired or wireless, terrestrial or satellite networking links, local area networks, wide area networks, internetworks, or a combination thereof and can comprise the public internet. Network 30 can include one or more cellular radiotelephone receivers, towers, and base stations, with interfaces to internetworks such as the public internet. Server computer 18 can comprise a desktop computer, rack-mounted server, and/or one or more virtual compute instances of a public or private data center or cloud computing service. The host application 20 is compatible with the mobile app 140 and can maintain a virtual link or session connection to the mobile app, as illustrated via a broken line.

Networked storage 22 comprises any of disk storage local to the server computer 18, network attached storage, and/or one or more virtual storage instances of the same or a different public or private data center or cloud computing service. The networked storage 22 is programmed to store a plurality of camera images 24 using a file system, folder system, directory, or other means of organizing digital files. In an embodiment, the networked storage 22 is configured to use encryption and decryption on the fly as camera images 24 are stored in or retrieved from the networked storage 22. Alternatively, host application 20 or services of the server computer 18 can be programmed to execute encryption and decryption functions. Furthermore, in an embodiment, networked storage 22 stores a database 26, which can be a relational database, object database, flat file system, no-SQL database, or other data repository. The database 26 is programmed according to a table schema that supports storing user account data such as usernames, credentials such as passwords and two-factor authentication methods, encryption keys or other credentials, subscription plan details, and metadata about camera images 24.

In an embodiment, the camera device 10 comprises a solid-state digital camera in enclosure 101, a lens 102, a light source 104, and a control unit 106. In one embodiment, the camera device 10 further comprises a transceiver 107, which can be a cellular radiotelephone transceiver or a short-range wireless networking transceiver in various embodiments. In one embodiment, the enclosure 101 may be wearable and can include a means of attachment to clothing or to a person, including but not limited to a spring clip, belt clip, bracket, magnet, arm strap, chest strap, carabiner, hook-and-loop fastener, lanyard, string, and necklace. The means of attachment enable a consumer or other individual user to wear the camera device 10 in a position in which the lens 102 faces outward, faces the environment, or otherwise is positioned to capture images of an object 108 based on light from the light source 104 reflected off the object and captured by the lens. Object 108 can comprise a person, structure, room, place, or any other item of interest capable of recording in a digital image. The enclosure 101 can be formed of injection-molded plastic, stamped sheet metal, extruded aluminum, or 3D printed resin or filament. The particular material used for enclosure 101 is not critical but typically will be rigid and lightweight to facilitate wearing on apparel, around the neck or attached to a limb. The enclosure 101 can comprise a bottom housing in which electronic components for the control unit 106 and power are mounted and a top shell that snugly holds or retains the lens 102. In some embodiments, enclosure 101 can comprise round, square, hexagonal, or other polyhedral shapes and it can be formed in or decorated using any of a plurality of different colors.

The term “lens” in reference to lens 102 broadly includes both an optical glass lens and a compatible solid-state digital camera capable of capturing light from light source 104 reflected off object 108 and forming digital images that can be digitally communicated to the control unit 106 via an appropriate interface. The lens 102 may be an infrared (IR) camera lens. The light source 104 may comprise one or more light-emitting diodes (LEDs), incandescent lamps, or other electric or electronic light sources that are coupled to the control unit 106 to selectively receive power from a power source such as a rechargeable battery under the control of stored program logic. The control unit 106 may comprise a microcontroller, microcomputer, volatile memory 109 such as RAM for transient storage of images from the lens 102, data, metadata, or other values needed to operate the control unit and camera device 10, and non-volatile memory storing a control program 111.

The control unit 106 is communicatively coupled to, or further comprises, the transceiver 107. In one embodiment, the transceiver 107 is a cellular radiotelephone transceiver capable of connecting wirelessly via the first wireless networking link 12A to a cell phone tower or base station 150 and communicating data via cellular radiotelephone protocols.

Alternatively, the transceiver 107 is configured to receive and transmit signals in the radio-frequency spectrum based on a wireless networking protocol. In this embodiment, the transceiver 107 is capable of pairing with a compatible transceiver of the mobile computing device 14 to communicate data on the first wireless networking link 12B. In various embodiments, the transceiver 107 and the wireless networking protocol can use Bluetooth, Wi-fi Direct, Near-field Communication (NFC), Zigbee, and Z-Wave.

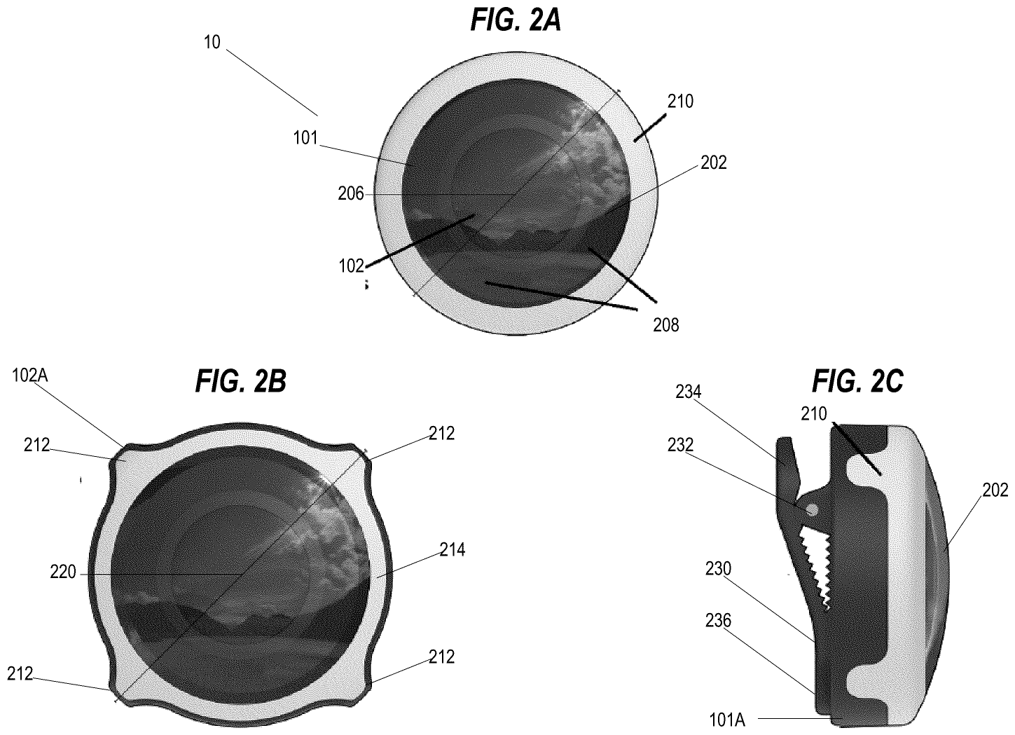

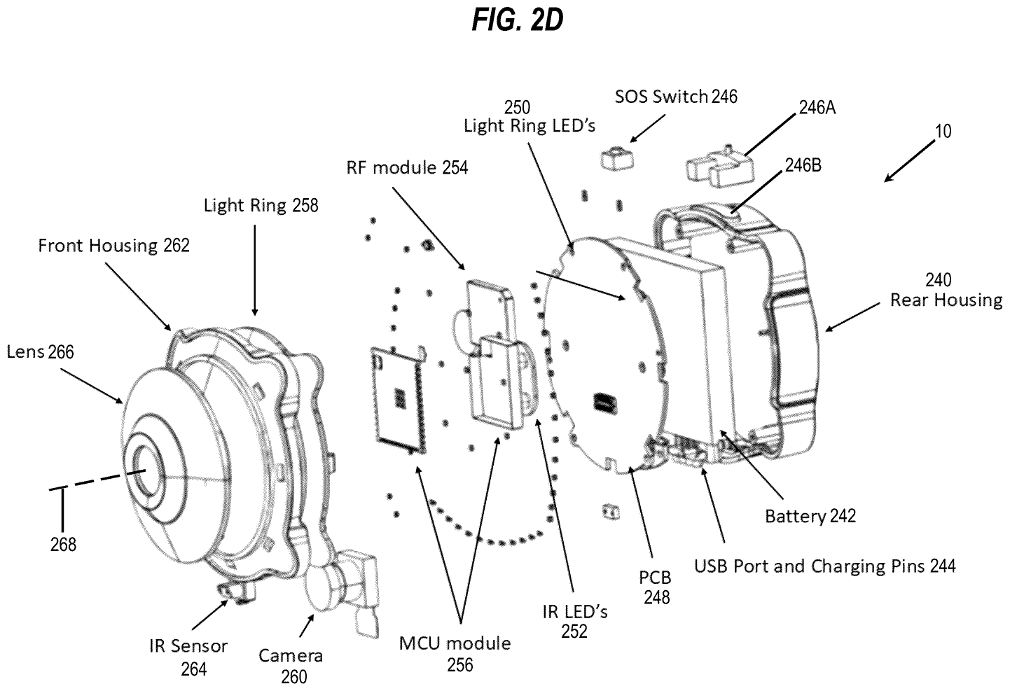

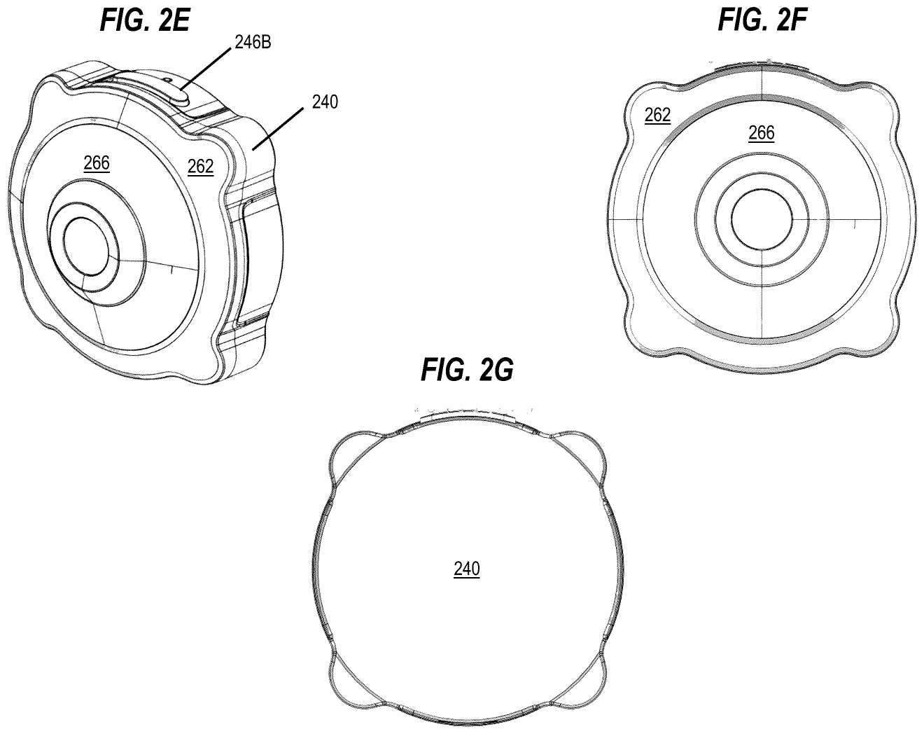

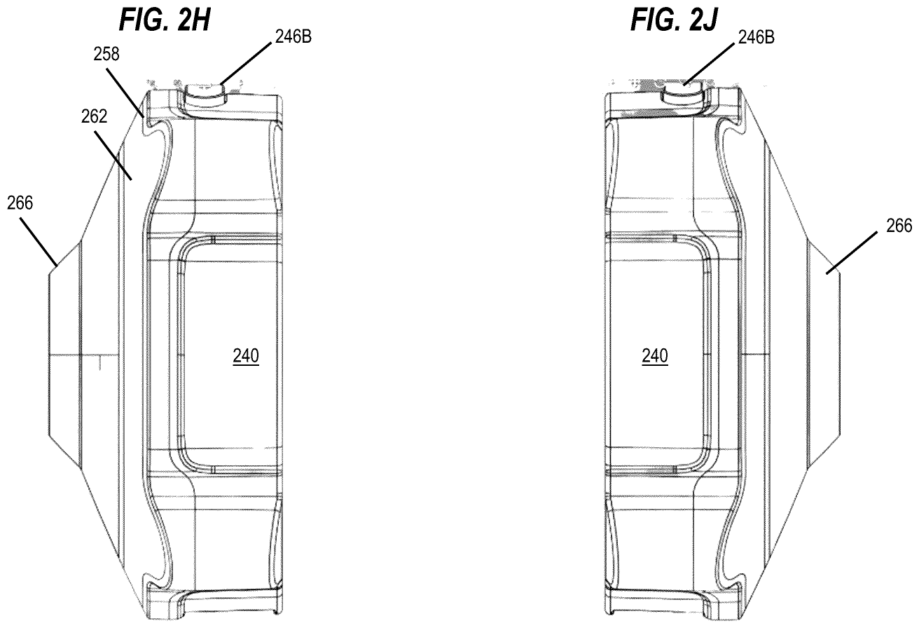

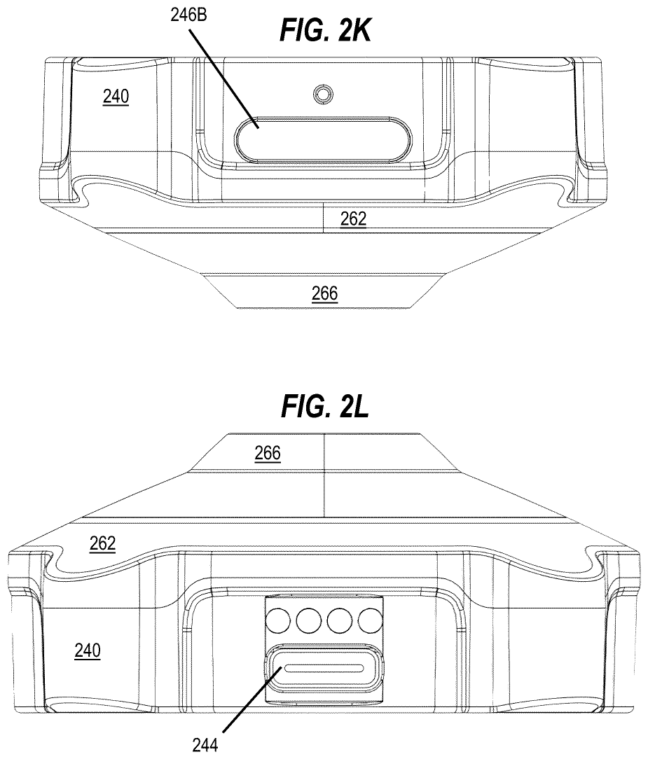

FIG. 2A is a front elevation view of one embodiment of the camera device 10. In an embodiment, the camera device 10 comprises the lens 102 mounted in a generally cylindrical enclosure 101 under a circular transparent lens cover 202. In one example, enclosure 101 has a perimeter diameter 206 of approximately 50-60 mm, but other embodiments can use other sizes. In an embodiment, enclosure 101 has dimensions suitable to enable the camera device 10 to be worn on apparel, worn around the neck, attached to a limb such as a forearm, or to be otherwise wearable.

One or more infrared lights 208, such as infrared LEDs, are mounted on enclosure 101 and under the lens cover 202. Infrared LEDs can enhance the recording of digital images of persons, animals, or other objects 108 that have a heat signature visible in the infrared spectrum. In such an embodiment, the digital camera in enclosure 101 can be configured to capture digital images in the infrared and visible light spectra. In an embodiment, the camera device 10 further comprises an LED ring light 210 mounted on or integrally formed with the enclosure 101. In some embodiments, the LED ring light 210 comprises interleaved arrays of bright white and blue LEDs; with this arrangement, the white LEDs provide lighting to facilitate capturing digital images, and the blue LEDs act as annunciators to suggest or imply to persons in the surrounding area that digital video or image recording is in use. In one embodiment, the control unit 106 comprises an LED flasher circuit having a driver output coupled to the blue LEDs to enable those LEDs to flash independently of the white LEDs, which may be continuously lit. In other embodiments, different combinations of static and flashing LED colors may be used, and blue and white are provided only as examples. Further, “white,” in this context, can comprise any useful color temperature, typically in the range of 2000K to 6000K.

FIG. 2B is a front elevation view of a second embodiment of the camera device. In the example of FIG. 2B, the LED light ring 102A is formed with a plurality of outwardly extending protrusions 212. The protrusions 212 can assist in aligning the camera device 10 in a position that is level and upright when mounted on apparel or a person by visually enabling the observer to find level or horizontal lines of alignment between the protrusions. The protrusions 212 also can act as finger grips when installing or removing the camera device on apparel or a person.

FIG. 2C is a side elevation view of the first embodiment of FIG. 2A. As shown, the lens cover 202 may be formed as a convex transparent dome or plate, and the LED ring light 210 can comprise a translucent cover or filter having a plurality of rearwardly extending tabs that mate with corresponding recesses in a bottom wall 101A of the enclosure 101. In one embodiment, a spring clip 230 formed of injection-molded plastic with a spring steel spring 232 can be formed integrally with or affixed to the bottom wall 101A using adhesive or fasteners such as self-tapping screws. In this arrangement, depressing an upper arm 234 causes a lower arm 236 to open, enabling affixing the camera device 10 to an item of apparel, and releasing the upper arm causes the spring 232 to urge the lower arm against the apparel to snugly hold the camera device 10 in position.

FIG. 2C is a side elevation view of the first embodiment of FIG. 2A. FIG. 2D is an exploded view of another embodiment of the camera device. FIG. 2E is a perspective view of the camera device of FIG. 2D. FIG. 2F is a front elevation view, and FIG. 2G is a rear elevation view of the camera device of FIG. 2D. FIG. 2H is a left-side elevation view, and FIG. 2J is a right side elevation view of the camera device of FIG. 2D. FIG. 2K is a top plan view, and FIG. 2L is a bottom plan view of the camera device of FIG. 2D. Referring first to FIG. 2A, in an embodiment, a camera device 10 comprises a rear housing 240 having a planar rear face and perimeter upstanding walls forming an interior recess into which a battery 242 is mounted. The battery 242 may comprise a dry cell battery or a rechargeable battery. A rechargeable battery can use suitable battery chemistry for portable consumer devices. Examples include Lithium-ion (Li-ion), Lithium Polymer (LiPo), Nickel-Metal Hydride (NiMH), Nickel-Cadmium (NiCd), and Lithium Iron Phosphate (LiFePO4).

USB port and charging pins 244 are mounted in the rear housing 240. The battery 242 is mechanically and electrically coupled to a plurality of charging pins to enable an external power supply to connect to the battery for use in charging the battery. A printed circuit board (PCB) 248 mounts on the rear housing 240 over the battery and comprises copper circuit traces and current-limiting resistors coupled to a plurality of light-emitting diodes arranged in a ring and thus termed light ring LEDs 250 in FIG. 2D. An emergency switch or SOS switch 246 mounts in the housing under pushbutton 246 and can fit in a switch carrier 246A.

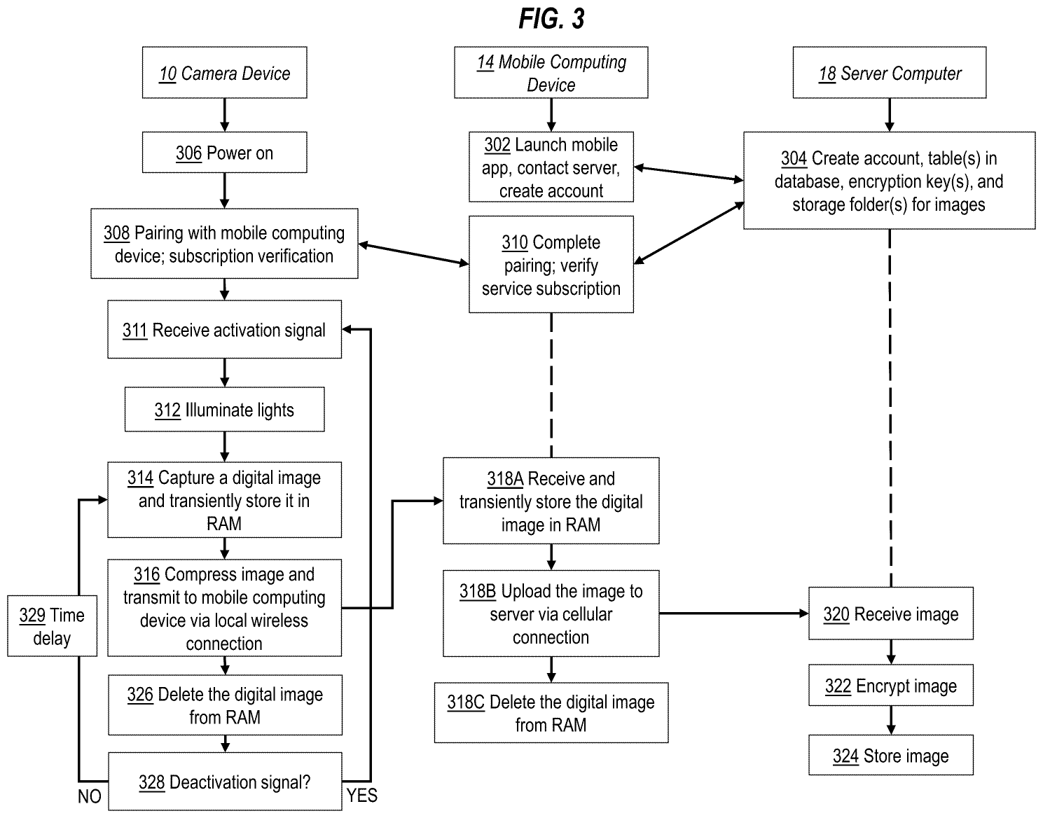

On PCB 248, a radio frequency (RF) module 254 is affixed along with a microcomputer unit (MCU) module 256. The RF module 254 can embody the transceiver 107 that has been described previously. The MCU module 256 comprises volatile and non-volatile memory coupled to the MCU; the non-volatile memory can store a control program. For example, the MCU module 256 is programmed with firmware instructions programmed to execute the example data processing flows described in connection with FIG. 3. In an embodiment, the USB port can be used to upload new programming to the MCU module 256.

In an embodiment, a lens 266 having a central longitudinal axis 268 mounts to a front housing 262, backed by a light ring 256 configured to diffuse or dissipate and outwardly transmit light emitted from light ring LEDs 250 when the LEDs are powered. A camera 260 and infrared (IR) sensor 264 are mounted in alignment with the axis 268 behind the lens and within the front housing. The IR sensor 264 and camera 260 are electrically and communicatively coupled to the MCU module 256. In various embodiments, the MCU module 256 or the PCB 248 comprise one or more LED driver circuits that are electrically coupled to the light ring LEDs 250 to enable the MCU module to drive and activate the LEDs under stored program control. In this arrangement, the light ring LEDs 250 can be powered to emit light outwardly and thus to the left of FIG. 2D. In one embodiment, the light ring LEDs 250 are decorative but capable of implicitly communicating that image capture or video recording is occurring when the LEDs are illuminated. Additionally, or alternatively, the LEDs 250 can be selected and paired with appropriate current-limiting resistors to emit bright white or soft white light to supplement ambient light to capture good-quality images. The IR sensor 264 also faces outwardly or to the left and is capable of capturing infrared radiation from persons or other heat sources near the camera device 10.

FIG. 2E, FIG. 2F, FIG. 2G, FIG. 2H, FIG. 2J, FIG. 2K, and FIG. 2L provide alternate views to more clearly illustrate the camera device of FIG. 2D in an assembled form. The foregoing parts can be assembled and fixed in place using a plurality of screws, tabs and slots, or interlocking tabs and recesses. The specific mechanical means of attachment is not critical. As seen in FIG. 2E, when assembled, the parts form a lightweight, compact unit capable of attachment to wearing apparel, a lanyard, a clip, or other means of attachment to or hanging from apparel or an appendage of the human body.

### 2.2 Example Data Processing Flows

FIG. 3 illustrates an example process of operating a camera device and applications in one embodiment. FIG. 3 and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

In one embodiment, when the camera device 10 is active, the LED lights are on, and the camera captures a digital image every three seconds or according to another time interval. The control unit 106 compresses the digital image and sends the image via the short-range wireless networking link 12 to the mobile computing device 14, which sends the image to cloud storage via server computer 18. Alternatively, control unit 106 may transceiver 107 to transmit the image directly to cloud storage via a cell signal. Thereafter, digitally stored images captured from the camera device 10 can be accessed securely via trained and authorized personnel associated with a service provider that owns, operates, or controls the server computer 18 if a crime has been committed or another valid reason for access to the images is defined and sent to the LEO computing device 40. In an embodiment, a cell phone app is used to subscribe to the service and contact the service provider for support.

The camera device 10 is also programmed to communicate with the user's cell phone to verify an active subscription, thus allowing the camera to take photos and allowing the LED lights to be activated. In an embodiment, the user activates their subscription and device upon receipt. The user turns on the device and attaches the device to apparel or a body part by one of the means for attachment that have been previously described.

In some embodiments, via marketing communications that the service provider creates and disseminates, criminals will recognize the device and be deterred from approaching the user to do harm, knowing their photo has already been taken and uploaded to the cloud. Consequently, the device and method of this disclosure have the significant benefit of deterring criminals from approaching potential victims. In one embodiment, the device is noticeably lit and bright, and continuously captures digital images of the surrounding environment and uploads the images via wireless digital communication to networked storage. In one embodiment, the device comprises a lamp, light, or LED that illuminates and/or flashes continuously when the device is operating, capturing, and uploading images. Continuous flashing communicates to observers or implies that images are being captured and stored or uploaded. The implication or suggestion that image capture and storage are occurring has been found to impart a significant deterrent effect on criminals.

Referring now to FIG. 3, in one embodiment, the use of the computing system 100 commences at block 302 when the mobile app 140 is launched. In an embodiment, operating the mobile app 140 causes the app to contact the host application 20 of the server computer 18 and to prompt the user to create an account. As shown in block 304, in an embodiment, the initial operation of the mobile app 140 In some embodiments, creating an account can include selecting a subscription plan and providing payment data or storing card data for payment processing. Further, creating an account can comprise updating the database 26 to enter user account data, creating and storing unique encryption keys, and creating and storing one or more folders in the networked storage 22 to store camera images 24 associated with a particular user account. When encryption keys are created, they are stored only at the server computer 18, host application, networked storage, or database 26 and not delivered or provided to a user of the camera device 10 or mobile computing device 14. The role of controlled encryption in this manner is further described in other sections. The impact is that the user of the camera device 10 is unable to access digital images that the camera captures and the mobile computing device 14 uploads to the cloud.

In an embodiment, before or after creating an account, at block 306, power is applied to the camera device 10, which initiates operation via a bootstrap loader of the control unit 106 or firmware programming in NVRAM of the control unit. Under stored program control, control unit 106 initiates short-range wireless networking and/or pairing with the mobile computing device 14, as shown by block 308. Or, the camera device 10 can comprise a pushbutton or other input device that the user can use to signal the camera device to initiate pairing. Pairing at block 308 can also include transmitting one or more digital messages to request account or subscription details and/or to validate or verify that the camera device 10 is associated with a valid user account or subscription. At block 310, the mobile computing device 14 participates in and completes the pair operation and transmits parameterized HTTP messages or app protocol messages to the host application 20 to verify the user account or service subscription. The result of these steps is that the camera device 10 is capable of short-range wireless communication with the mobile computing device 14, and the camera device and mobile app 140 are authorized or verified to conduct digital image capture, upload, and storage operations.

In an embodiment, after block 310, camera device 10 enters an idle state in which it is available but not then currently capturing or uploading digital images. In an embodiment, at block 311, the camera device 10 receives an activation signal. In some embodiments, applying power to the camera device 10 automatically acts as the activation signal; in other embodiments, the camera device can comprise a dedicated pushbutton or other hardware element for the user to signal activation. In some embodiments, the mobile app 140 can include an activation function that the user can select by tapping or clicking on a GUI widget, app widget, or other control, and the mobile app transmits an activation signal to the camera device 10 via the short-range wireless networking connection.

In response to receiving the activation signal, at block 312, the camera device 10 illuminates the lights on the camera device. The stored program of control unit 16 can be programmed to detect a keypress of a pushbutton or other hardware element and to energize an LED driver circuit to illuminate the lights on the camera device.

At block 314, control unit 16 enters a programmed loop. A digital image is captured and transiently stored in the volatile memory of the camera device 10. In some embodiments, the camera device comprises a relatively small RAM chip capable of transiently storing only a few digital images. At block 316, the control unit 16 is programmed to digitally compress or encode the digital image that was captured and to transmit the compressed or encoded digital image to the mobile computing device 14 via a local wireless networking connection, for example, using connection 12 and any of Bluetooth, Wi-fi Direct, Near-field Communication (NFC), Zigbee, or Z-Wave.

At block 318A, the mobile computing device 14 receives the digital image; the mobile app 140 is programmed to transiently store the digital image in volatile memory. At block 318B, the mobile app 140 is programmed to upload the digital image to the server computer 18 via a cellular radiotelephone data connection. In some embodiments, if another connection like Wi-fi is available and enabled, then the mobile app 140 can select that connection and transmit the digital image to the server computer 18 via the Wi-fi connection. At block 320, the host application 20 receives the image. In some embodiments, at block 322, the host application 20 is programmed to encrypt the received digital image using an encryption key or key pair that is uniquely associated with a user account of a user of the mobile app 140 and/or camera device 10. To support correct encryption, messages of the mobile app 140 associated with the upload operation at block 318B can include a handshake, preface, or header message or element that digitally specifies or identifies a user account, user identifier, or app instance identifier to signal what entity is presenting the digital image for storage. At block 324, the digital image is stored in networked storage 22.

At block 318C, the mobile app 140 is programmed to delete the digital image from the volatile memory. In some embodiments, executing block 318C can occur only after the mobile app 140 receives a handshake or validation signal from the host application 20 specifying that a complete digital image file was received; packet drops, losses, or other failures can be addressed using a retry protocol.

At block 326, camera device 10 is programmed to delete the digital image from volatile memory. “Delete,” in this context, can include marking the digital image as deleted, so that a subsequent iteration of block 314 will overwrite the same address range of memory, effectively deleting the first image. Or, deleting can comprise de-allocating an address range of memory or overwriting the digital image with null values or other specified values.

The transient storage and deletion steps of blocks 314, 326, 318A, and 318C support the privacy and security goals of embodiments. For example, the digital image captured at block 314 could include a representation of the face of an individual in a setting or location in which the consent of that individual to be recorded cannot be inferred or implied. Applicable laws or regulations could prohibit or limit video recording or digital image captures in certain locations, environments, or circumstances. The use of transient storage and deletion, and encrypted cloud storage, in which digital images that the camera device 10 captures are not persistently stored locally at the camera device or mobile computing device 14 supports compliance with privacy or security laws or regulations. Further, as described, the captured digital images are stored only in cloud storage, using encryption, and the user of the camera device and mobile computing device 14 or app 140 does not receive or access the encryption or decryption keys or protocols. Therefore, only a service provider that owns, operates, or controls the server computer 18, host application 20, and networked storage 22 can access, decrypt, or view the stored digital images. In an embodiment, access, decrypting, or viewing are possibly only in response to a lawful request of authorized law enforcement or court personnel or in response to a court order in connection with a civil or criminal legal matter. In all other circumstances, no one, including the user who originally captured the digital images, can access, decrypt, or view the images.

At block 328, camera device 10 is programmed to detect whether a deactivation signal is received. A deactivation signal instructs the camera device 10 to cease collecting digital images. The deactivation signal can be provided via a pushbutton or other hardware element of the camera device 10. In some embodiments, the mobile app 140 can include a deactivation function that the user can select by tapping or clicking on a GUI widget, app widget, or other control, and the mobile app transmits a deactivation signal to the camera device 10 via the short-range wireless networking connection. If the deactivation signal was received, control transfers to block 311 at which the control unit 106 waits to receive an activation signal again or a power-down signal.

In an embodiment, if the deactivation signal was received, control transfers to block 314 to capture another digital image and repeat the steps of blocks 316 to 326 inclusive for the next or subsequent digital image. In some embodiments, control unit 106 executes a time delay 329 before completing a transfer of control to block 314. The time delay 329 interposes a delay between capturing successive digital images. The time delay 329 can range from a few milliseconds to several seconds. In one embodiment, a one-second to five-second delay is used. In some embodiments, the time delay 329 can be configured via settings in the mobile app 140 and transmitted to the camera device 10 via the short-range wireless networking connection after a configuration change occurs. In some embodiments, configuring a short time delay 329, which necessarily causes capturing and uploading more digital images over time, requires a higher-priced service or subscription. Another embodiment could support real-time continuous video recording or simulated real-time video recording using fewer than 24-30 frames per second in exchange for higher or premium subscription pricing.

In another embodiment, transceiver 107 uses cellular radiotelephone networking to transmit directly to the network 30 and server computer 18. In such an embodiment, pairing at block 308 is not required; at block 316, transmission occurs via cellular networking and the transceiver 107 without using a local wireless connection; and the operations of blocks 318A to 318C inclusive are not required. Instead, at block 316, the image is transmitted to server computer 18 using a cellular connection of camera device 10 to the network 30 and the server computer, and after block 316 the control flow of block 320 to block 324 occurs.

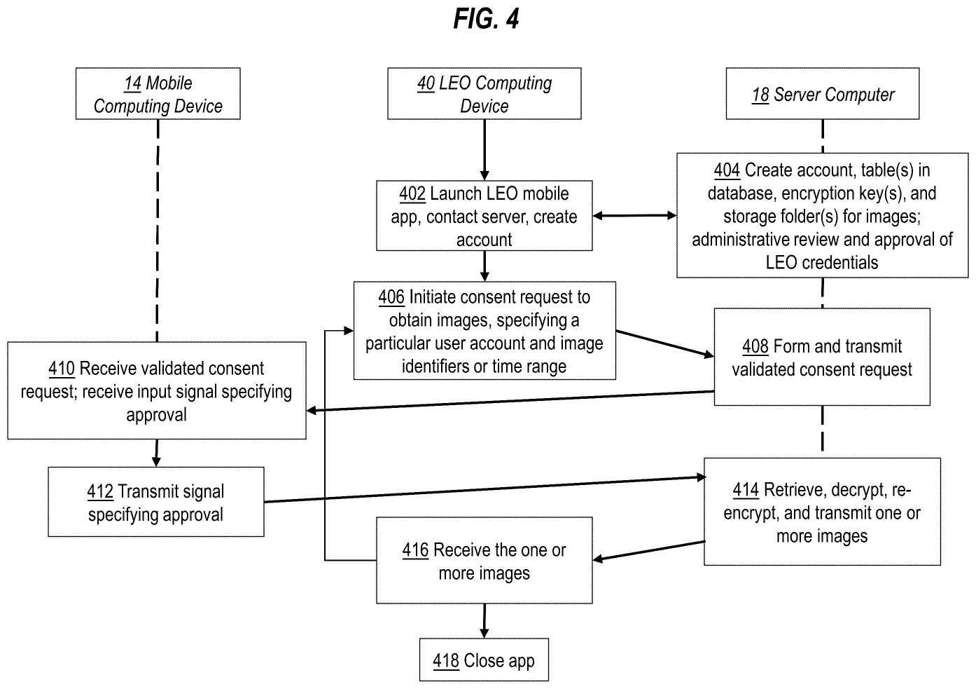

FIG. 4 illustrates an example program flow associated with law enforcement access to stored digital images. “Law enforcement” or “law enforcement officer” in this disclosure refers broadly to any person authorized by a government to undertake legal proceedings, including civil or criminal proceedings. In various embodiments, the service provider of the control domain 28 defines the institutions and personnel to which the service provider will grant access to camera images 24, independently or in compliance with national, regional, or local laws or regulations and the conditions of that access. The access conditions and the operation of FIG. 4 or steps within FIG. 4 could also be defined according to a consent decree, court order, judicial decision, law, or regulation that the service provider lacks discretion to vary.

At block 402, assume that an individual LEO officer or LEO computing device 40 launches the LEO mobile app 142, which contacts the server computer 18 to create an account for the officer, an agency, or an institution. At block 404, the host application 20 is programmed to create an account, tables in database 26, encryption or decryption keys, and storage folders for images. Block 404 can also involve non-automated administrative review and approval of the credentials, authentication of identity, authorization, and access rights of an individual LEO, agency, or institution.

In an embodiment, the LEO mobile app 142 is specially programmed with LEO-only functionality to facilitate the operations described in FIG. 4 and can be subject to limited downloading or distribution only to authorized LEOs, agencies, or institutions. For example, the LEO mobile app 142 can be programmed with a function not available in the mobile app 140 to request access to the camera images 24 associated with a specified user or account. At block 406, in one embodiment, the LEO computing device via the LEO mobile app 142 initiates a consent request to obtain images, specifying a particular user account and image identifiers or time range. The specific data required in the LEO mobile app 142 to define a consent request can vary in different embodiments. For example, the LEO mobile app 142 could require the LEO to enter the mobile phone number of the mobile computing device 14 or a user account identifier of a user associated with the camera device 10 and mobile computing device. The process presumes that the LEO and the user have had some prior oral or written communication in which the user has reported a crime or other incident and indicated the intent to cooperate with the LEO or that the LEO has obtained a court order, warrant, or other authorization to access the camera images 24 of a specified user, account, or mobile phone number. The LEO mobile app 142 transmits the request to the host application 20.

At block 408, the host application 20 forms and transmits a validated consent request to the mobile computing device 14. For example, the host application 20 can be programmed to generate and transmit an app protocol message to the mobile app 140, which causes the mobile app to generate and display a notification on the mobile computing device 14, prompting the user to review a consent request. The validated consent request of block 408 can specify a time range of images, image identifiers, or thumbnails of images for which access consent is being requested. “Validated,” in this context, means that the host application 20 has determined that the mobile phone number or user account identifier in the request of block 406 is in the database 22, associated with an active user account, and associated with at least one image among the camera images 24. Validation also can include determining that the LEO computing device 40 and/or LEO app 142 are recognized, that an LEO has logged in with proper credentials, or other steps like two-factor authentication to ensure that the LEO, the LEO computing device 40 and/or LEO app 142 are authenticated and authorized to execute the operations of FIG. 4. Other validation criteria can be applied to an inbound request in other embodiments.

At block 410, the mobile computing device 14 receives the validated consent request followed by an input signal specifying approval. Block 410 represents the mobile app 140 receiving and displaying the consent request, prompting the user to review and manifest consent to the request, and receiving a tap, click, or other input signal from the user indicating consent to the request. At block 412, the mobile computing device 14 transmits a signal specifying approval of the request to the server computer 18.

In response, at block 414, the server computer 18 retrieves, decrypts, and transmits one or more images from the camera images 24 to the LEO computing device 40. Block 414 can comprise securely accessing a key store to identify and read a decryption key associated with the user account of the camera device 10 and/or mobile computing device 14.

At block 416, the LEO computing device 40 receives one or more images from the server computer 18. In some embodiments, the LEO computing device 40 can view the images but not store them using the LEO app 142. In other embodiments, store, copy, and forward operations can be integrated into the LEO app 142 or allowed using other apps running on the LEO computing device 40. After block 416, the LEO computing device 40 optionally closes the LEO app 142 at block 418 or initiates another request at block 406.

### 3. Implementation Example—Hardware Overview

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

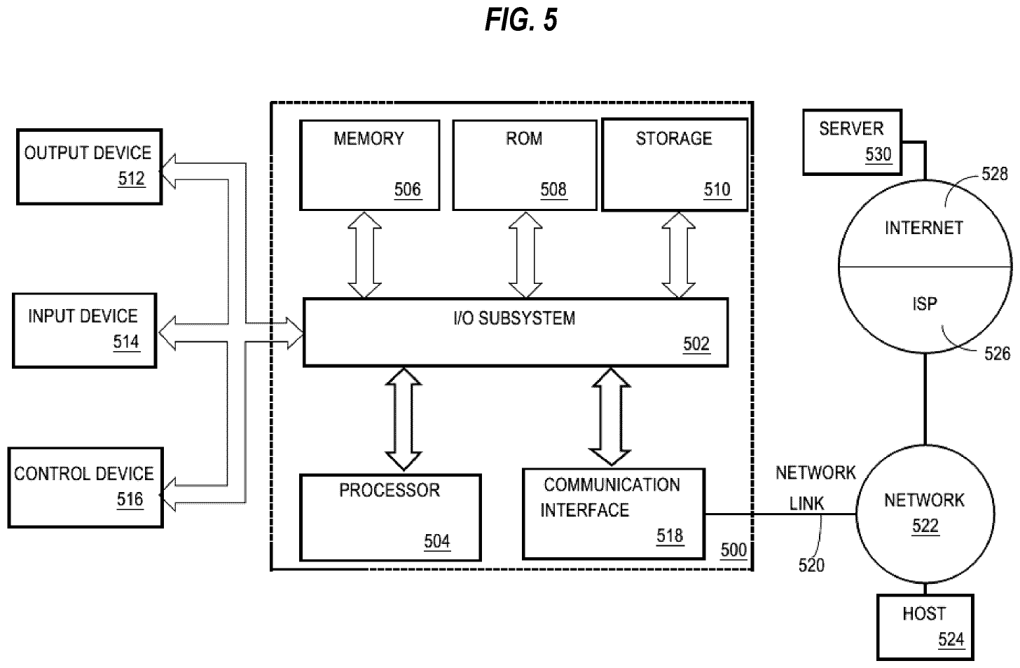

FIG. 5 is a block diagram that illustrates an example computer system with which an embodiment may be implemented. In the example of FIG. 5, a computer system 500 and instructions for implementing the disclosed technologies in hardware, software, or a combination of hardware and software, are represented schematically, for example, as boxes and circles, at the same level of detail that is commonly used by persons of ordinary skill in the art to which this disclosure pertains for communicating about computer architecture and computer systems implementations.

Computer system 500 includes an input/output (I/O) subsystem 502, which may include a bus and/or other communication mechanism(s) for communicating information and/or instructions between the components of the computer system 500 over electronic signal paths. The I/O subsystem 502 may include an I/O controller, a memory controller, and at least one I/O port. The electronic signal paths are represented schematically in the drawings, such as lines, unidirectional arrows, or bidirectional arrows.

At least one hardware processor 504 is coupled to I/O subsystem 502 for processing information and instructions. Hardware processor 504 may include, for example, a general-purpose microprocessor or microcontroller and/or a special-purpose microprocessor such as an embedded system or a graphics processing unit (GPU), or a digital signal processor or ARM processor. Processor 504 may comprise an integrated arithmetic logic unit (ALU) or be coupled to a separate ALU.

Computer system 500 includes one or more units of memory 506, such as a main memory, coupled to I/O subsystem 502 for electronically digitally storing data and instructions to be executed by processor 504. Memory 506 may include volatile memory such as various forms of random-access memory (RAM) or other dynamic storage device. Memory 506 may also be used for storing temporary variables or other intermediate information during the execution of instructions to be executed by processor 504. Such instructions, when stored in non-transitory computer-readable storage media accessible to processor 504, can render computer system 500 into a special-purpose machine customized to perform the operations specified in the instructions.

Computer system 500 includes non-volatile memory such as read-only memory (ROM) 508 or other static storage devices coupled to I/O subsystem 502 for storing information and instructions for processor 504. The ROM 508 may include various forms of programmable ROM (PROM), such as erasable PROM (EPROM) or electrically erasable PROM (EEPROM). A unit of persistent storage 510 may include various forms of non-volatile RAM (NVRAM), such as FLASH memory, solid-state storage, magnetic disk, or optical disks such as CD-ROM or DVD-ROM and may be coupled to I/O subsystem 502 for storing information and instructions. Storage 510 is an example of a non-transitory computer-readable medium that may be used to store instructions and data which, when executed by the processor 504, cause performing computer-implemented methods to execute the techniques herein.

The instructions in memory 506, ROM 508, or storage 510 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation, application, and data storage layer, such as a relational database system using a structured query language (SQL) or no SQL, an object store, a graph database, a flat file system, or other data storage.

Computer system 500 may be coupled via I/O subsystem 502 to at least one output device 512. In one embodiment, output device 512 is a digital computer display. Examples of a display that may be used in various embodiments include a touchscreen display, a light-emitting diode (LED) display, a liquid crystal display (LCD), or an e-paper display. Computer system 500 may include other type(s) of output devices 512, alternatively or in addition to a display device. Examples of other output devices 512 include printers, ticket printers, plotters, projectors, sound cards or video cards, speakers, buzzers or piezoelectric devices or other audible devices, lamps or LED or LCD indicators, haptic devices, actuators or servos.

At least one input device 514 is coupled to I/O subsystem 502 for communicating signals, data, command selections, or gestures to processor 504. Examples of input devices 514 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. The control device 516 may be a touchpad, a mouse, a trackball, or cursor direction keys for communicating direction information and command selections to processor 504 and for controlling cursor movement on an output device 512, such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other control device. An input device 514 may include a combination of multiple input devices, such as a video camera and a depth sensor.

In another embodiment, computer system 500 may comprise an Internet of Things (IoT) device in which one or more of the output device 512, input device 514, and control device 516 are omitted. Or, in such an embodiment, the input device 514 may comprise one or more cameras, motion detectors, thermometers, microphones, seismic detectors, other sensors or detectors, measurement devices or encoders, and the output device 512 may comprise a special-purpose display such as a single-line LED or LCD display, one or more indicators, a display panel, a meter, a valve, a solenoid, an actuator or a servo.

When computer system 500 is a mobile computing device, input device 514 may comprise a global positioning system (GPS) receiver coupled to a GPS module that is capable of triangulating to a plurality of GPS satellites, determining and generating geo-location or position data such as latitude-longitude values for a geophysical location of the computer system 500. Output device 512 may include hardware, software, firmware, and interfaces for generating position reporting packets, notifications, pulse or heartbeat signals, or other recurring data transmissions that specify a position of the computer system 500, alone or in combination with other application-specific data, directed toward host computer 524 or server computer 530.

Computer system 500 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 500 in response to processor 504 executing at least one sequence of at least one instruction contained in main memory 506. Such instructions may be read into main memory 506 from another storage medium, such as storage 510. Execution of the sequences of instructions contained in main memory 506 causes processor 504 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct but may be used with transmission media. Transmission media participates in transferring information between storage media. For example, transmission media includes coaxial cables, copper wire and fiber optics, and wires comprising a bus of I/O subsystem 502. Transmission media can also be acoustic or light waves generated during radio-wave and infrared data communications.

Various forms of media may carry at least one sequence of at least one instruction to processor 504 for execution. For example, the instructions may initially be carried on a remote computer's magnetic disk or solid-state drive. The remote computer can load the instructions into its dynamic memory and send them over a communication link such as a fiber optic, coaxial cable, or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal, and appropriate circuitry can provide the data to I/O subsystem 502, such as placing the data on a bus. I/O subsystem 502 carries the data to memory 506, from which processor 504 retrieves and executes the instructions. The instructions received by memory 506 may optionally be stored on storage 510 either before or after execution by processor 504.

Computer system 500 also includes a communication interface 518 coupled to a bus or I/O subsystem 502. Communication interface 518 provides a two-way data communication coupling to a network link(s) 520 directly or indirectly connected to at least one communication network, such as a network 522 or a public or private cloud on the Internet. For example, communication interface 518 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 522 broadly represents a local area network (LAN), wide-area network (WAN), campus network, internetwork, or any combination thereof. Communication interface 518 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 518 sends and receives electrical, electromagnetic, or optical signals over signal paths that carry digital data streams representing various types of information.

Network link 520 typically provides electrical, electromagnetic, or optical data communication directly or through at least one network to other data devices, using, for example, satellite, cellular, Wi-Fi, Bluetooth, or other short-range radiofrequency networking technology. For example, network link 520 may connect through network 522 to a host computer 524.

Furthermore, network link 520 may connect through network 522 or to other computing devices via internetworking devices and/or computers operated by an Internet Service Provider (ISP) 526. ISP 526 provides data communication services through a worldwide packet data communication network called Internet 528. A server computer 530 may be coupled to Internet 528. Server computer 530 broadly represents any computer, data center, virtual machine, or virtual computing instance with or without a hypervisor or computer executing a containerized program system such as DOCKER or KUBERNETES. Server computer 530 may represent an electronic digital service that is implemented using more than one computer or instance, and that is accessed and used by transmitting web services requests, uniform resource locator (URL) strings with parameters in HTTP payloads, API calls, app services calls, or other service calls. Computer system 500 and server computer 530 may form elements of a distributed computing system that includes other computers, a processing cluster, a server farm, or other organizations of computers that cooperate to perform tasks or execute applications or services. Server computer 530 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 530 may comprise a web application server that hosts a presentation layer, application layer, and data storage layer, such as a relational database system using a structured query language (SQL) or no SQL, an object store, a graph database, a flat file system or other data storage.

Computer system 500 can send messages and receive data and instructions, including program code, through the network(s), network link 520, and communication interface 518. In the Internet example, server computer 530 might transmit a requested code for an application program through Internet 528, ISP 526, local network 522, and communication interface 518. The received code may be executed by processor 504 as it is received and/or stored in storage 510 or other non-volatile storage for later execution.

The execution of instructions, as described in this section, may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 504. While each processor 504 or core of the processor executes a single task at a time, computer system 500 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes. In an embodiment, for security and reliability, an operating system may prevent direct communication between independent processes, providing strictly mediated and controlled inter-process communication functionality.

### 4. Benefits and Advantages; Extensions and Alternatives

The device and method of this disclosure have the significant benefit of deterring criminals from approaching potential victims. In one embodiment, the device is noticeably lit and bright, and continuously captures digital images of the surrounding environment and uploads the images via wireless digital communication to networked storage. In one embodiment, the device comprises a lamp, light, or LED that illuminates and/or flashes continuously when the device is operating, capturing, and uploading images. Continuous flashing communicates to observers or implies that images are being captured and stored or uploaded. The implication or suggestion that image capture and storage are occurring has been found to impart a significant deterrent effect on criminals.

In the foregoing specification, embodiments of the invention have been described with reference to numerous specific details that may vary from implementation to implementation. Accordingly, the specification and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A camera device comprising:
a digital camera;
an outwardly facing light source that is communicatively coupled to a control unit;
a transceiver communicatively coupled to the control unit;
a volatile memory coupled to the control unit; and
a non-volatile memory coupled to the control unit and storing a control program which, when executed using the control unit, causes the control unit to execute:
receiving account verification information via the transceiver;
illuminating the light source;
capturing a digital image via the digital camera and storing the digital image in the volatile memory;
transmitting the digital image via the transceiver to a networked storage device;
automatically deleting the digital image from the volatile memory; and
after a time delay, repeating the capturing, storing, transmitting, and deleting.

2. The camera device of claim 1 further comprising a wearable enclosure that contains the digital camera, the control unit, the transceiver, the volatile memory, and the non-volatile memory.

3. The camera device of claim 2, further comprising, attached to the wearable enclosure, means for attaching the wearable enclosure to apparel or to a human body part.

4. The camera device of claim 3, wherein the means for attaching comprises a spring clip.

5. The camera device of claim 1, wherein the transceiver comprises a short-range wireless transceiver, wherein the control program when executed using the control unit causes the control unit to execute transmitting the digital image via the short-range transceiver to a mobile computing device.

6. The camera device of claim 5, wherein the short-range transceiver is a Bluetooth transceiver.

7. The camera device of claim 1, wherein the light source comprises one or more visible light light-emitting diodes (LEDs).

8. The camera device of claim 1, wherein the light source comprises one or more static visible light LEDs, one or more colored LEDs, and one or more infrared (IR) spectrum LEDs.

9. A distributed computing system comprising:
a camera device comprising a digital camera, an outwardly facing light source that is communicatively coupled to a control unit, a short-range transceiver communicatively coupled to the control unit, a first volatile memory coupled to the control unit, a non-volatile memory coupled to the control unit and storing a control program which, when executed using the control unit, causes the control unit to execute:
illuminating the light source;
capturing a digital image via the digital camera and storing the digital image in the first volatile memory;
transmitting the digital image via the short-range transceiver to a mobile computing device;
deleting the digital image from the first volatile memory; and
after a time delay, repeating the capturing, storing, transmitting, and deleting; and
a mobile app comprising one more first sequences of instructions configured to store in a first non-transitory computer-readable storage media of the mobile computing device and which instructions, when executed using the mobile computing device, cause the mobile computing device to execute:
receiving the digital image in a second volatile memory of the mobile computing device;
in response to receiving the digital image, transmitting the digital image via a cellular radiotelephone data transceiver of the mobile computing device and over a data communication network to a server computer; and
deleting the digital image from the second volatile memory.

10. The distributed computing system of claim 9, further comprising a second non-transitory computer-readable storage medium communicatively coupled to the server computer and storing one or more second sequences of instructions which, when executed using the server computer, cause the server computer to execute receiving the digital image from the mobile computing device, encrypting the digital image, and storing the digital image in a storage device after the encrypting.

11. The distributed computing system of claim 9, wherein the camera device further comprises a wearable enclosure that contains the digital camera, the control unit, the short-range transceiver, the first volatile memory, and the non-volatile memory.

12. The distributed computing system of claim 11, wherein the camera device further comprises, attached to the wearable enclosure, means for attaching the wearable enclosure to apparel or to a human body part.

13. The distributed computing system of claim 9, wherein the short-range transceiver is a Bluetooth transceiver.

14. The distributed computing system of claim 9, wherein the light source comprises one or more visible light LEDs.

15. The distributed computing system of claim 9, wherein the light source comprises one or more static visible light LEDs, one or more colored LEDs, and one or more infrared (IR) spectrum LEDs.

16. The distributed computing system of claim 9, wherein the non-volatile memory coupled to the control unit, when executed using the control unit, causes the control unit to execute receiving account verification information via the transceiver.

17. The distributed computing system of claim 9, wherein the non-volatile memory coupled to the control unit, when executed using the control unit, causes the control unit to execute, in response to receiving the account verification information, executing the capturing, storing, transmitting, and deleting at the camera device.

18. The distributed computing system of claim 9, wherein the light source comprises an LED ring light.

19. The camera device of claim 1, wherein the non-volatile memory coupled to the control unit, when executed using the control unit, causes the control unit to execute, in response to receiving the account verification information, executing the capturing, storing, transmitting, and deleting.

20. The distributed computing system of claim 1, wherein the light source comprises an LED ring light.
